(19) United States
(12) Patent Application Publication
(10) Pub. No.: US 2003/0204601 A1
(43) Pub. Date: Oct. 30, 2003

(54) Session relay system, client terminal, session relay method, remote access method, session relay program and client program

(75) Inventor: Kohji Takano, Fujisawa-shi (JP)

Correspondence Address: Jeanine S. Ray-Yarletts, IBM Corporation T81/503, P.O Box 12195, Research Triangle Park, NC, 27709, US

(73) Assignee: International Business Machines Corporation, Armonk, NY

(21) Appl. No.: 10/388,355

(22) Filed: Mar. 13, 2003

(30) Foreign Application Priority Data
Apr. 26, 2002 (JP) 2002-127686

(51) Int. Cl. G06F 15/16

(52) U.S. Cl. 709/227; 709/203

(57) ABSTRACT

To enable access to a server via telnet or the like even if access to the server via telnet or the like from an external network is limited by a firewall. In order to accomplish this, first and second sessions are conducted between first and second information processing systems 2, 1 according to first and second protocols and, by relaying between the first and second sessions, a third session is established between the first and second information processing systems. A processing result sent from the second information processing system 1 to the first information processing system 2 is stored in a buffer 35 of a session relay system 3 and transferred to the first information processing system 2 in response to an update request. With this arrangement, even if a firewall 6 preventing the second session from passing therethrough exists on the first session, a session can be established between the first and second information processing systems 2, 1, and further, even such a processing result that is sent while the first session is disconnected can also be received by the first information processing system.

### BACKGROUND OF THE INVENTION

The present invention relates to a session relay system that conducts first sessions with a first information processing system according to a first protocol, and a second session with a second information processing system according to a second protocol, and relays between the plurality of first sessions and the one second session to establish a third session composed of those sessions, and further relates to a network system including such a session relay system, and to a client terminal, a session relay method, a remote access method, a session relay program and a client program that are suitable thereto.

Telnet is known as a protocol for sending/receiving character information to and from a remote server, thereby to use a resource of the remote server. Telnet allows a computer on the client's side to remotely login to a server connected via TCP/IP so as to be used as a virtual terminal. Thus, in a TCP/IP-based network environment, any clients can use a server inasmuch as the server opens a port to telnet.

On the other hand, for ensuring security, firewalls are generally provided between the Internet and company networks. Such a network configuration is generally adopted in companies, wherein a network is managed by dividing it into two segments with a firewall interposed therebetween, one of the segments is used as a DMZ (DeMilitarized Zone) with a public server disposed therein, and the other is used as a company network. In the firewall of this type for general companies, a telnet port is not opened to the Internet in view of security. Therefore, while telnet has been widely used in Unix (TM) computers, it has not been normally used within company networks in companies. For accessing a server in a company network from the outside via telnet, a method has been generally used to directly establish a dial-in connection to the company network.

However, the company networks have been expanding, not limited in the companies, and those companies having worldwide company networks have been increasing. Therefore, there has been a strong demand for safely accessing servers in the company networks from anywhere via telnet on the Internet, using mobile devices such as personal computers or portable telephones. There has also been a demand for accessing networks of other companies from a certain company network via the Internet.

Therefore, it is an object of the present invention to provide a technique that enables access to a server via telnet or the like even if access to the server from an external network via telnet or the like is limited by a firewall.

### SUMMARY OF THE INVENTION

For accomplishing the foregoing object, according to the present invention, there is provided a session relay system that conducts first sessions with a first information processing system according to a first protocol, and a second session with a second information processing system according to a second protocol, and relays between the plurality of first sessions and one of the second sessions to establish a third session composed of those sessions, the session relay system comprising session managing means for producing ID (identification) information for identifying the third session that is established in response to a connection request from the first information processing system, and sending the ID information to the first information processing system having made the connection request; and processing result transfer means for sending data of a processing result to the first information processing system, the data of the processing result sent from the second information processing system in response to a processing request sent from the first information processing system along with the ID information.

Further, according to the present invention, there is provided a session relay method that conducts first sessions with a first information processing system according to a first protocol, and a second session with a second information processing system according to a second protocol, and relays between the plurality of first sessions and one the second session to establish a third session composed of those sessions, the session relay method comprising a session managing step of producing ID information for identifying the third session that is established in response to a connection request from the first information processing system, and sending the ID information to the first information processing system having made the connection request; and a processing result transfer step of sending data of a processing result to the first information processing system, the data of the processing result sent from the second information processing system in response to a processing request sent from the first information processing system along with the ID information.

Further, a session relay program according to the present invention causes a computer to function as the foregoing session relay system according to the present invention.

In the invention of the foregoing session relay system, session relay method or session relay program, the session relay system or the session relay program is formed by, for example, a web server and a servlet running in the web server. As the first information processing system, a portable telephone adapted to i-appli or a personal computer having a WWW browser that can execute an applet, for example, may be cited. “i-appli” is a Java (TM) program that is operated in a portable telephone when accessing the web. As the second information processing system, a server in an intranet protected by a firewall, for example, may be cited. As the first protocol, HTTP1.0 may be cited, for example, wherein when one communication based on a request and a response is finished, a session (connection) is disconnected. As the second protocol, a protocol like telnet that can not normally pass through a firewall and thus can not be used for accessing a server in an intranet via the Internet, may be cited, for example. Further, “a plurality of first sessions” does not represent a plurality of first sessions that are multiplexed relative to a plurality of first information processing systems, but represents a plurality of first sessions that occur discontinuously on a time basis relative to one first information processing system. The third session represents a logical connection established between applications of the first and second information processing systems.

In the invention of the foregoing session relay system, session relay method or session relay program, when a connection request is issued from the first information processing system via the first session, the session relay system produces ID information for identifying the third session that is established in response to the connection request, and sends it to the first information processing system. Thereafter, when a processing request along with the ID information is received from the first information processing system via the first session constituting the established third session, the session relay system sends the processing request to the second information processing system via the second session constituting the established third session. When data of a processing result sent from the second information processing system in response to the processing request is received, the session relay system sends the received data to the first information processing system.

In this manner, the session relay system relays the processing request or the like between the first and second information processing systems while identifying the third session of the correctly corresponding first information processing system using the ID information. In this event, even if the second protocol can not pass through the firewall, by properly selecting the first protocol to allow the first session to pass through the firewall, the third session between the first information processing system located outside the firewall and the second information processing system located inside the firewall can be established and maintained.

In one mode of the invention of the foregoing session relay system, session relay method or session relay program, the processing result transfer means or the processing result transfer step comprises buffer means or a storing step of storing the data of the processing result sent from the second information processing system in response to the processing request, in a buffer correspondingly to the ID information sent along with the processing request, and update means or an update step of, responsive to an update request along with the ID information from the first information processing system, sending data in the buffer corresponding to the ID information to the first information processing system, the data in the buffer not yet sent to the first information processing system. The update request is made via the first session different from that for the connection request.

According to the foregoing mode, the data of the processing result is stored in the buffer, and sent to the first information processing system in response to the update request. Therefore, even if the first session is immediately disconnected due to the completion of the first response to the update request, the third session can be maintained without failure by storing, in the buffer, data sent from the second information processing system after the disconnection, thereby sending the stored data to the first information processing system in response to a subsequent update request.

As the buffer, a ring buffer provided per ID information can be used. The buffer means or the storing step adds the data of the processing result to the corresponding ring buffer, and sends the data of the processing result to the first information processing system along with position information relating to a position of the end of the added data in the ring buffer after the addition of the data, and further adds to the corresponding ring buffer in sequence data of the processing result that is sent subsequently to disconnecting the first session following the termination of the data sending to the first information processing system.

In this event, upon sending the data in response to the update request accompanied by the ID information, data subsequent to the position, which is sent along with the update request, in the ring buffer corresponding to the ID information is sent to the first information processing system.

In another mode of the invention of the foregoing session relay system, session relay method or session relay program, the first information processing system exists outside a first firewall, the session relay system and the second information processing system exist inside the first firewall, and the first session can be conducted by passing through the first firewall.

In this case, it may be arranged that the first session with the first information processing system is conducted by a third information processing system, and the second session with the second information processing system is conducted by a fourth information processing system capable of communicating with the third information processing system according to a third protocol, and that communication between the third and fourth information processing systems according to the third protocol is conducted by passing through a second firewall, the third information processing system has the session managing means or performs the session managing step, and the fourth information processing system establishes the second session with the second information processing system and relays between the communication according to the third protocol and the communication according to the second protocol.

Further, it may be arranged that the third information processing system comprises the session managing means, the buffer means and the update means, or the third information processing system performs the session managing step, the storing step and the update step, that the third information processing system sends to the fourth information processing system the connection request from the first information processing system and the ID information produced in response thereto, and the processing request along with the ID information from the first information processing system, and stores a socket relative to the fourth information processing system produced upon every occurrence of the connection request from the first information processing system, correspondingly to the ID information produced in response to the connection request, and that every time the connection request and the ID information produced in response thereto are sent, the fourth information processing system establishes the second session relative to the second information processing system correspondingly to the ID information and, when the processing request is sent via the socket, the fourth information processing system sends the received processing request to the second information processing system via the second session corresponding to the socket, and receives the processing result relative to the sent processing request, and then sends it to the third information processing system.

On the other hand, a network system according to the present invention comprises the foregoing session relay system according to the present invention, and the first and second information processing systems that are connected to each other by the third session established based on relaying performed by the session relay system.

A client terminal according to the present invention comprises connection requesting means for receiving a connection request for connection to a predetermined server and sending the connection request to a predetermined session relay system via a session according to a predetermined protocol; ID information receiving means for receiving ID information sent from the session relay system for identifying an upper session with the server, the upper session including the session and established in response to the connection request; processing requesting means for receiving a processing request to the server and sending the processing request to the session relay system along with the ID information; update requesting means for sending an update request to the session relay system along with the ID information, the update request requesting an update by data of a processing result sent from the server in response to the processing request and stored in the session relay system; and display means for displaying data sent from the session relay system in response to the update request.

A remote access method according to the present invention comprises a connection requesting step of receiving a connection request for connection to a server inside a firewall and sending the connection request to a session relay system inside the firewall via one session according to a protocol that can pass through the firewall; an ID information receiving step of receiving ID information sent from the session relay system for identifying an upper session with the server, the upper session including the one session and established in response to the connection request; a processing requesting step of receiving a processing request to the server and sending the processing request to the session relay system along with the ID information; an update requesting step of sending an update request to the session relay system along with the ID information via a session, other than the one session, according to the protocol and included in the upper session, the update request requesting an update by data of a processing result sent from the server in response to the processing request and stored in the session relay system; and a display step of displaying data sent from the session relay system in response to the update request.

A client program according to the present invention causes a client terminal to execute steps pursuant to the foregoing remote access method according to the present invention.

The client terminal, the server, the one session and the upper session in the invention of the foregoing client terminal, remote access method or client program correspond to the first information processing system, the second information processing system, the first session and the third session in the foregoing session relay system according to the present invention, respectively. As the predetermined protocol or the protocol that can pass through the firewall, HTTP may be cited, for example.

The invention of the foregoing client terminal, remote access method or client program also exhibits like operations and effects through cooperation with the invention of the foregoing session relay system, session relay method or session relay program.

In one mode of the invention of the foregoing client terminal, remote access method or client program, a position of the end of a ring buffer of the session relay system sent from the session relay system along with the data of the processing result is stored and, upon sending the update request, the stored newest position is sent simultaneously.

It may be arranged that the data of the processing result sent from the session relay system is stored in the ring buffer, thereby performing a history display wherein all the data stored in the ring buffer can be displayed in response to a history display request.

When the session relay system comprises a third information processing system that conducts the first session with the first information processing system (client terminal), and a fourth information processing system that conducts the second session with the second information processing system (server) and is capable of communicating with the third information processing system according to a third protocol, and communication between the third and fourth information processing systems according to the third protocol is conducted by passing through a second firewall, it may be arranged that the client terminal receives inputs of an IP address and a port number of the fourth information processing system of the session relay system and inputs of authentication information, an IP address and a port number relative to the server and stores them, and the foregoing connection requesting means or connection requesting step sends the stored various information simultaneously upon sending the connection request.

### BRIEF DESCRIPTION OF THE DRAWINGS

FIG. 1 is a diagram showing a configuration of a network system according to a preferred embodiment of the present invention.

FIG. 2 is a diagram hierarchically showing the network system of FIG. 1.

FIG. 3 is a diagram showing a system configuration in a web server in the network system of FIG. 1.

FIG. 4 is a diagram showing a system configuration in a client terminal in the network system of FIG. 1.

FIG. 5 is a diagram showing the states of using a portable terminal in the network system of FIG. 1.

FIG. 6 is a diagram showing the states of using a personal computer in the network system of FIG. 1.

FIG. 7 is a diagram showing a system configuration of a mapper in the network system of FIG. 1.

FIG. 8 is a diagram showing the flow of data upon login to a telnet server in the network system of FIG. 1.

FIG. 9 is a diagram showing the flow of data upon sending of a telnet command in the network system of FIG. 1.

FIG. 10 is a diagram showing the flow of data upon updating of a processing result relative to a telnet command in the network system of FIG. 1.

FIG. 11 is a diagram showing the flow of data upon logout from the telnet server in the network system of FIG. 1.

### DETAILED DESCRIPTION OF A PREFERRED EMBODIMENT

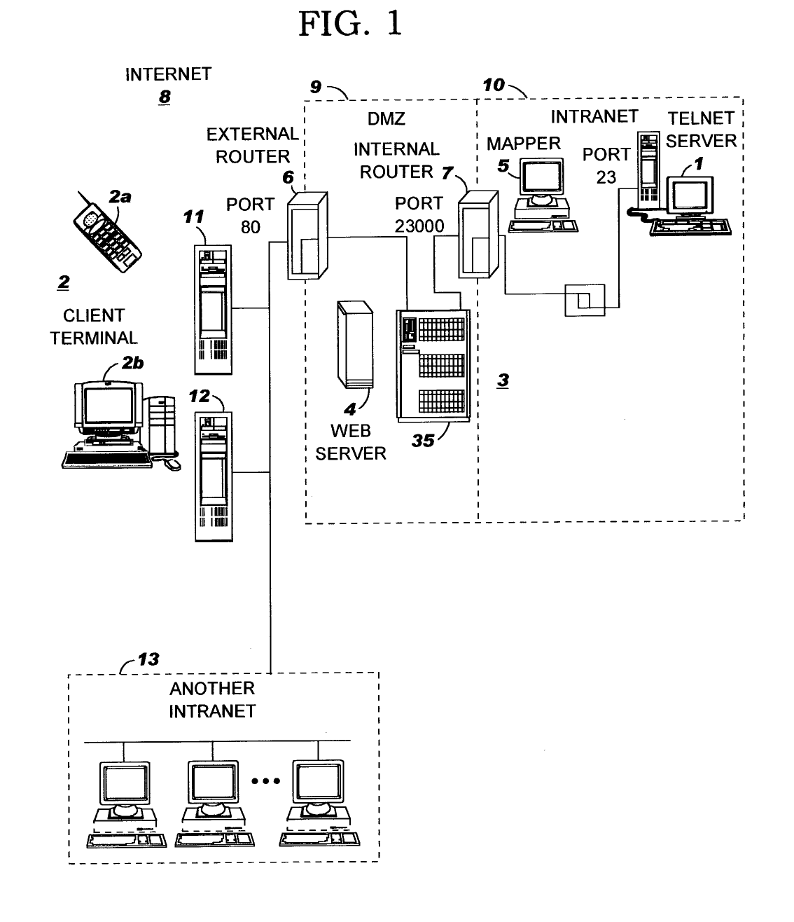

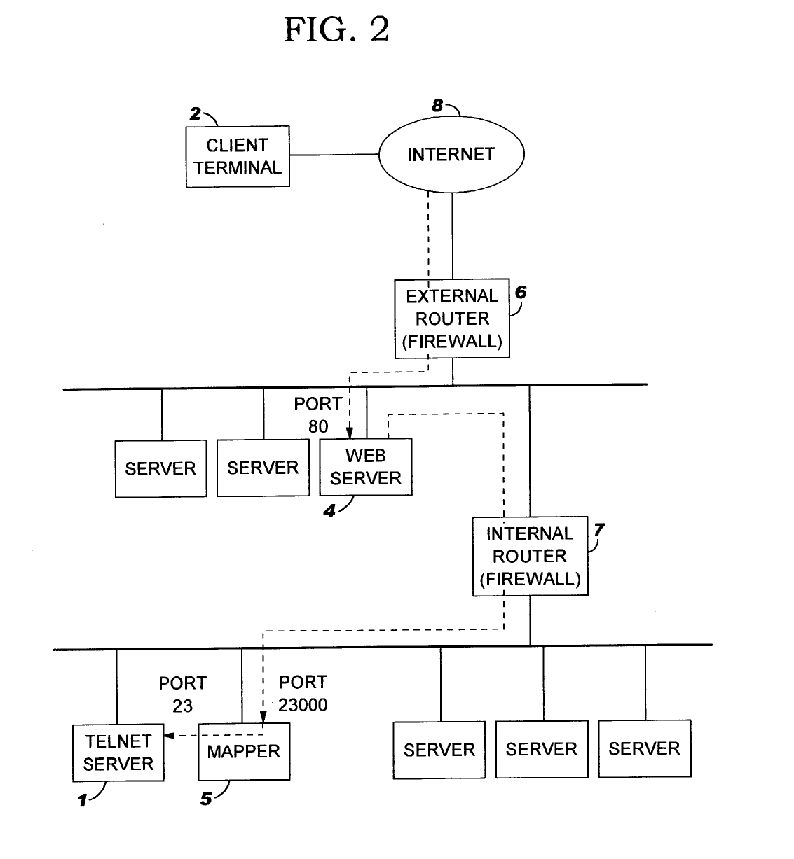

FIG. 1 shows a configuration of a network system according to a preferred embodiment of the present invention. FIG. 2 hierarchically shows this same embodiment. As shown in these figures, this system comprises a server (host) 1 offering a resource via telnet, a client terminal 2 receiving an offer of a resource, and a session relay system 3 relaying a session between the server 1 and the client terminal 2. The session relay system 3 can communicate with the server 1 via telnet and with the client terminal 2 via HTTP, and renders a plurality of sessions via HTTP correspond to one session via telnet so as to relay between those sessions, thereby establishing an upper session between the server 1 and the client terminal 2. The session relay system 3 is provided with a web server 4 and a mapper 5. The mapper 5 performs a relay with given protocol conversion in communication between the web server 4 and the server 1 and, when a plurality of different sessions occur between the web server 4 and the server 1, the mapper 5 performs mapping so as to maintain connection of each session. Specifically, directly, the mapper 5 conducts a session with the server 1 via telnet. As the client terminal 2, a portable terminal 2a adapted to i-appli or a personal computer 2b having a web browser adapted to a Java (TM) applet, for example, may be used. The portable terminal 2a and the personal computer 2b have ring buffers 11 and 12, respectively, for storing display data.

Firewalls 6 and 7 are interposed between the client terminal 2 and the web server 4 and between the web server 4 and the mapper 5, respectively, for dividing the network into network segments of the Internet 8, a DMZ (DeMilitarized Zone) 9 and an intranet (company LAN) 10, thereby to improve security in the intranet 10. The firewall 6 carries out filtering so as to pass a packet with a TCP destination port 80 from the internet 8, while discard a packet with a destination port 23. Accordingly, the client terminal 2 can establish connection to the web server 4 via HTTP through the Internet 8 and passing the firewall 6, but can not access to the web server 4 via telnet. The firewall 7 passes a packet with a destination port 23000.

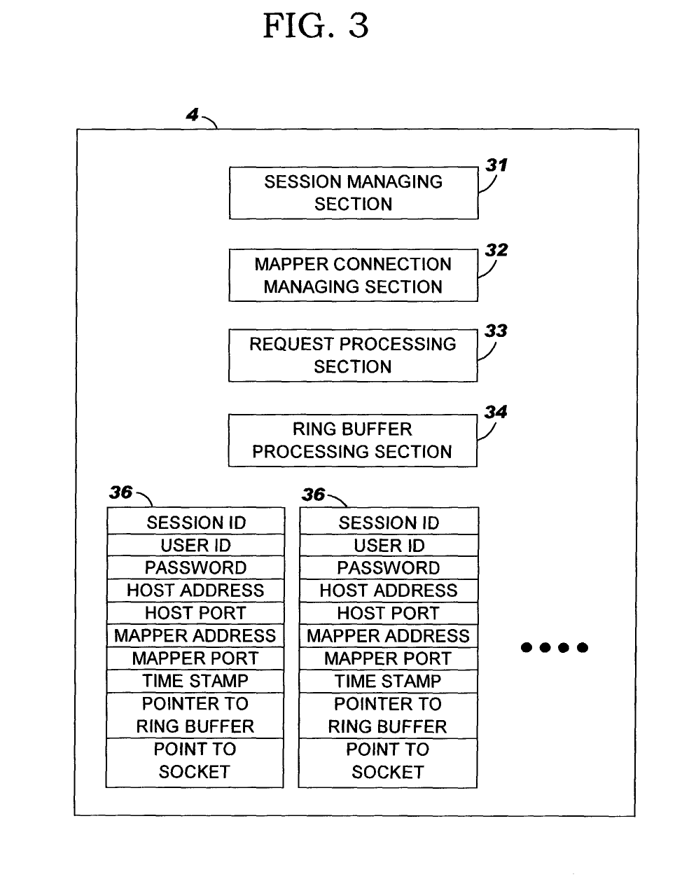

FIG. 3 shows a system configuration relating to the present network system in the web server 4. The system of the web server 4 is created by a Java (TM) servlet constantly loaded in the web server 4. As shown in the figure, the system of the web server 4 comprises a session managing section 31 for managing sessions conducted between the server 1 and the client terminal 2, a mapper connection managing section 32 for managing connection to the mapper 5, a request processing section 33 for implementing processing relative to the client terminal 2, and a ring buffer processing section 34 for implementing processing relating to ring buffers 35. Numeral 36 denotes a region for storing session information necessary for maintaining a session between the client terminal 2 and the server 1.

In response to a connection request from the client terminal 2, the session managing section 31 produces a session ID for identifying a session established between the server 1 and the client terminal 2, and sends it to the client terminal 2 that has made the connection request, and further manages an effective term of the session ID. For example, if a request accompanying a certain session ID is not made from the client terminal 2 over 10 minutes, the session managing section 31 invalidates that session ID and terminates the session. Along with the produced session ID, a user ID for login via telnet, a password, an IP address of the server 1 (host address), a port number of the server 1 (host port) for telnet, an IP address of the mapper 5 (mapper address), and a port number for connection to the mapper 5 (mapper port), which are sent from the client terminal 2 along with the connection request, and further a time stamp showing a current time in millisecond unit, a pointer indicating an address of a corresponding ring buffer 35, and a socket to be used for connection to a corresponding application process in the mapper 5, are retained by the session managing section 31 as session information per session ID. The session information is stored in the region 36 upon the start of a session with the server 1, and deleted upon the termination of the session.

The mapper connection managing section 32 performs connection, disconnection and sending/receiving of data relative to the mapper 5, and manages an effective term of connection to the mapper 5. For example, if a term with no data transmission/reception relative to the mapper 5 continues over 10 minutes, the mapper connection managing section 32 performs disconnection from the mapper 5. In response to a request from the client terminal 2 via HTTP pursuant to GET and POST methods, the request processing section 33 sends back a response message thereto.

The ring buffer processing section 34 stores data sent from the server 1 in response to sending of a processing request that was sent from the client terminal 2 along with a session ID, in the buffer 35 correspondingly to the session ID. Further, in response to an update request from the client terminal 2 along with a session ID, the ring buffer processing section 34 sends to the client terminal 2 data in the buffer 35 corresponding to the session ID.

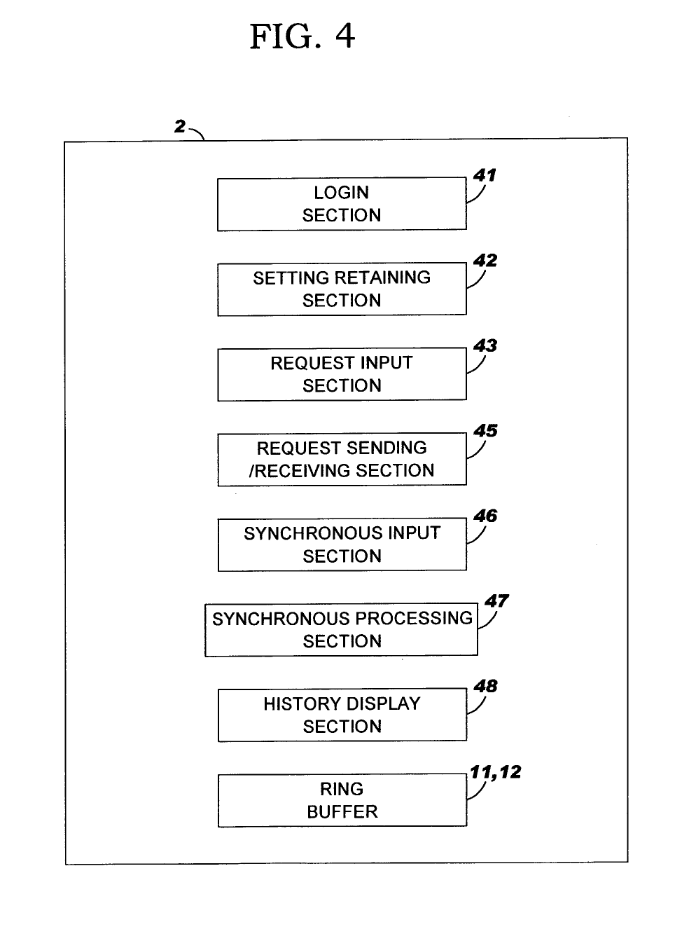

FIG. 4 shows a system configuration in the client terminal 2. As shown in the figure, the client terminal 2 comprises a login section 41 for receiving a login command from a user, a setting retaining section 42 for receiving inputs of various setting data and storing them, a request input section 43 for receiving a telnet command as a processing request to the server 1, a request sending/receiving section 45 for sending a processing request directed to the server 1 and receiving a processing result sent in response to such a processing request, a synchronous input section 46 for receiving an update request for the processing result, a synchronous processing section 47 for updating data in the ring buffer 11 or 12 in response to the update request, and a history display section 48 for displaying data in the ring buffer 11 or 12 as a history in response to a history display request.

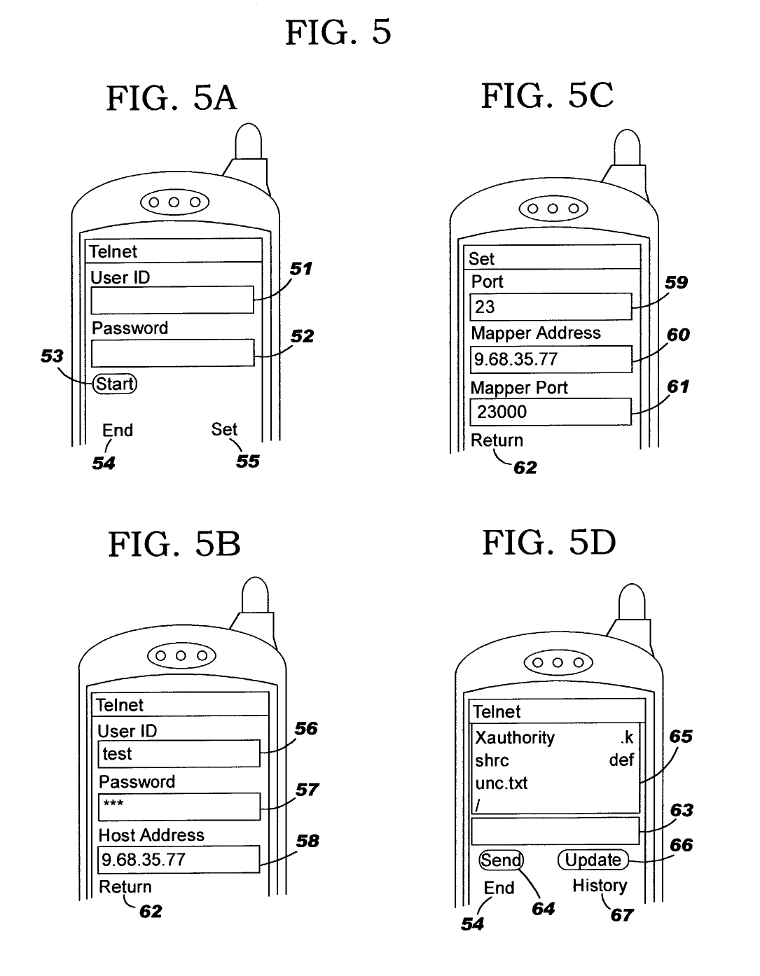

FIG. 5 shows the states of using the present network system in the portable terminal 2a. FIG. 5 at (a) shows a login window displayed when starting up the i-appli that realizes the present network system. In the figure, numeral 51 denotes a display region of a user ID, and numeral 52 denotes a display region of a password. If a user ID, a password and so on are set in a later-described setting window, those are displayed in the display regions 51 and 52. Numeral 53 denotes a button for starting a session with the server 1, numeral 54 denotes a button for finishing the i-appli, and numeral 55 denotes a button for displaying setting windows shown in FIG. 5 at (b) and (c). The setting window of FIG. 5 at (c) can be displayed by scrolling the setting window of FIG. 5 at (b).

In FIG. 5 at (b) and (c), numerals 56 to 61 denote input fields for inputting various information to be identified for starting a session with the server 1. The input fields 56 and 57 are inputted with a user ID and a password necessary for login to the server 1 via telnet. The input fields 58 and 59 are inputted with an IP address of the server 1 (host address) and a port number for telnet. The input fields 60 and 61 are inputted with an IP address of the mapper 5 (mapper address) through which the session with the server 1 is conducted, and a port number to be used for connection to the mapper 5 (mapper port). Numeral 62 denotes a button for returning to the login window of FIG. 5 at (a).

FIG. 5 at (d) shows a session window displayed when a session is started by depression of the button 53. In the figure, numeral 63 denotes an input field of a telnet command, numeral 64 denotes a button for sending an input command to the server 1, and numeral 65 denotes a display region for displaying a processing result in response to the sent command. Numeral 66 denotes a button for updating a display of the processing result, and numeral 67 denotes a button for displaying a history of the processing result.

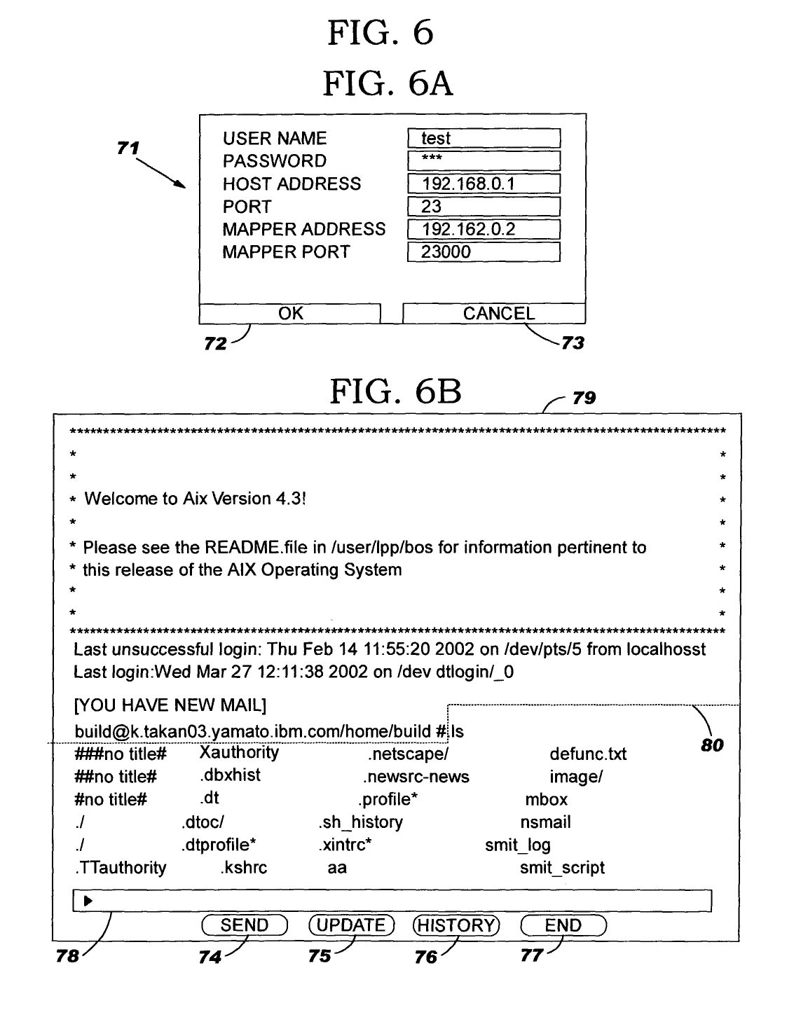

FIG. 6 shows the states of using the present network system in the personal computer 2b. In the personal computer 2b, functions relating to the present network system are realized by the Java (TM) applet executed on the browser. FIG. 6 at (a) shows a setting window, wherein an input field 71 corresponds to the input fields 56 to 61 in FIG. 5. In the figure, numeral 72 denotes a button for starting a session with the server 1 based on various information inputted to the input field 71, and numeral 73 denotes a button for canceling the processing executed by the Java (TM) applet.

FIG. 6 at (b) shows a session window displayed when a session is started by depression of the button 72. In the figure, buttons 74 to 77 correspond to the buttons 64, 66, 67 and 54, respectively. Numeral 78 denotes an input field of a telnet command, and numeral 79 denotes a display region for displaying a processing result with respect to an input command.

The login section 41 shown in FIG. 4 is inputted with depression of the start button 53 shown in FIG. 5 at (a). The setting retaining-section 42 retains various information inputted in the setting windows of FIG. 5 at (b) and (c) or in the setting window of FIG. 6 at (a). The retained information is maintained inasmuch as it is not deleted, and can be used as it is in the next session. The request input section 43 receives commands that are inputted using the command input field 63 or 78. The commands include, for example, “ls” for displaying the content of a directory, “copy” for copying a file, and “cd” for changing the current directory.

A request sent by the request sending/receiving section 45 is delivered to the web server 4 as a message of a GET request and a POST request pursuant to HTTP. In response thereto, the request sending/receiving section 45 receives a message of a GET response and a POST response from the web server 4. Sending of an update request and receiving of update data are performed by a GET request and a GET response, while login and logout relative to the server 1 via telnet, and sending of a telnet command and receiving of a processing result are performed by a POST request and a POST response.

The synchronous input section 46 receives depression of the update button 66 or 75. In response to depression of the update button 66 or 75, the synchronous processing section 47 sends data representing the state of the ring buffer 11 or 12 in the client terminal 2, i.e. position data representing which portion of data in the ring buffer 35 of the web server 4 has already been acquired, to the web server 4. Then, the synchronous processing section 47 adds to the ring buffer 11 or 12 update data sent from the web server 4 in response to such position data, and displays the update data in the display region 65 or 79. In response to depression of the history button 67 or 76, the history display section 48 displays data stored in the ring buffer 11 or 12.

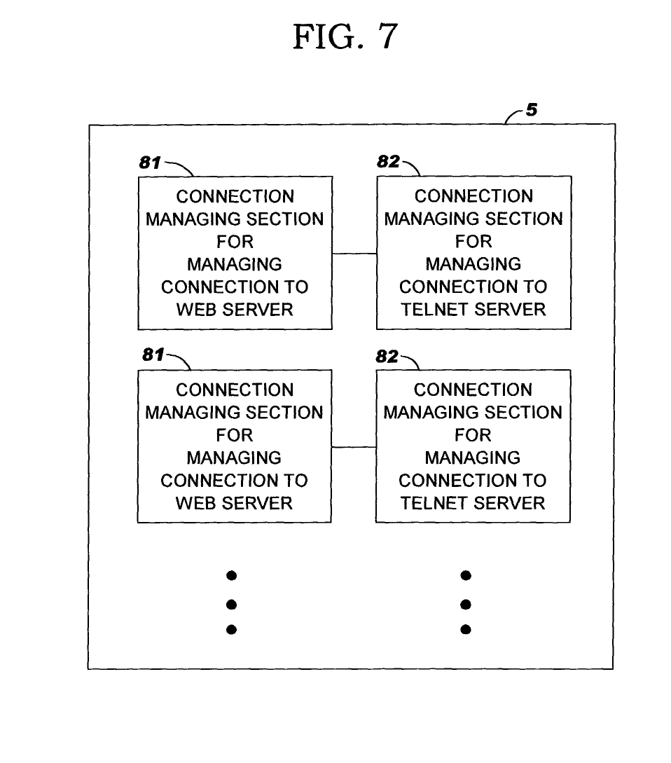

FIG. 7 shows a system configuration of the mapper 5. The mapper 5 comprises connection managing sections 81 each for managing connection to a servlet of the web server 4, and connection managing sections 82 each for managing connection to the server 1. The connection managing section 81 allocates commands sent from the mapper connection managing section 32 of the web server 4, to respective processing routines and sends them to the connection managing section 82, and sends data sent from the mapper connection managing section 32, to the connection managing section 82, while sends data sent from the connection managing section 82, to the mapper connection managing section 32 of the web server 4. The commands sent from the mapper connection managing section 32 include, for example, “DLOGIN” and “DLOGOUT” for requesting login and logout via telnet relative to the server 1, and “DTATA” for requesting sending of a telnet command to the server 1. For example, when the “DLOGIN” command is received, the connection managing section 82 negotiates with the server 1 to establish connection, thereby to start a telnet session. On the other hand, when the “DTATA” command is received, the connection managing section 82 sends an accompanying telnet command to the server 1, and then sends data sent from the server 1 in response thereto, to the connection managing section 81. The connection managing sections 81 and 82 are produced as respective threads of a processing routine for each of sessions between a plurality of client terminals 2 and one server 1, and perform mapping of application processes of a sender and a destination in each session. Specifically, the sessions between the plurality of client terminals 2 and the server 1 can be established in a multiplex fashion. The mapper 5 opens a port 23000 to the web server 4, while the server 1 opens a port 23 for telnet. Accordingly, the destination port is converted by the mapper 5.

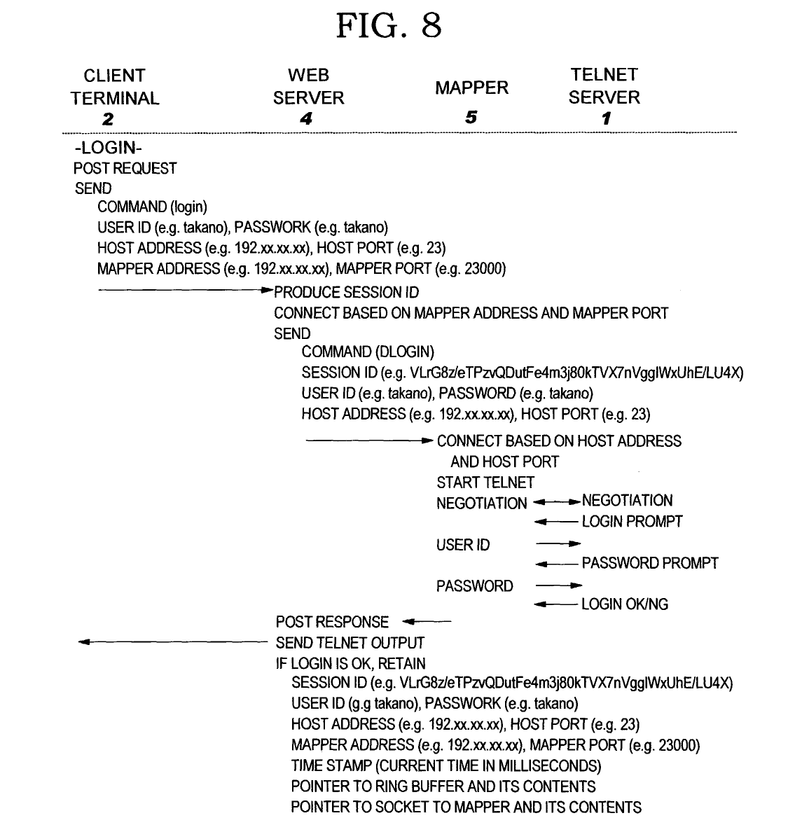

FIGS. 8 to 11 show the flow of data among the client terminal 2, the web server 4, the mapper 5 and the telnet server 1 upon login to the telnet server 1, upon sending of a telnet command, upon updating of a processing result relative to the telnet command, and upon logout from the telnet server 1, respectively. Referring to FIGS. 8 to 11, operations of the network system will be described.

For remotely operating the server 1 via telnet using the client terminal 2, it is necessary to first download the i-appli or applet relating to the present network system from a given download page of the web server 4. When the portable terminal 2a downloads the i-appli, the web server 4 judges whether a production number of the portable terminal 2a is registered, and permits the download only when it is registered. Thus, for downloading the i-appli, it is necessary that the production number for identifying the portable terminal 2a be notified to a system administrator beforehand so that access permission is granted through registration of the production number in the web server 4 by the system administrator. On the other hand, when the personal computer 2b downloads the applet, the web server 4 performs client authentication and permits the download only when the positive authentication result is obtained.

When the i-appli or applet is downloaded and started, the login section 41 displays the login window as shown in FIG. 5 at (a). When the set button 55 is depressed, the setting retaining section 42 displays the setting window of FIG. 5 at (b) or FIG. 6 at (a). Then, when the scroll operation is performed in case of the portable terminal 2a, the setting window is scrolled to that of FIG. 5 at (c). When information such as a user ID, a password and a host address necessary for login to the server 1 is inputted, the setting retaining section 42 stores those setting data. In case of the portable terminal 2a, when the return button 62 is depressed, the login window is displayed again and, in this event, the user ID and the password (indication of ***) inputted in the setting window are displayed in the display regions 51 and 52. When the start button 53 or the OK button 72 is depressed, the request sending/receiving section 45 sends to the web server 4 via an HTTP session, a login command “login” as a POST request, and data of a user ID, a password, a host address, a host port, a mapper address and a mapper port retained by the setting retaining section 42, as shown in FIG. 8.

When the foregoing data is received, the session managing section 31 of the web server 4 produces a session ID, and the mapper connection managing section 32 forms a socket to the mapper 5 based on the mapper address and the mapper port thereby to establish connection, and sends the command “DLOGIN”, the produced session ID, and the received data of the user ID, the password, the host address and the host port to the mapper 5.

When the mapper 5 receives the foregoing data, the connection managing section 82 of the mapper 5 carries out negotiations to establish TCP connection with the server 1 based on the received host address and host port and, when login prompt is sent from the server 1, the connection managing section 82 sends the received user ID to the server 1 in response to login prompt. Further, when password prompt is sent from the server 1, the connection managing section 82 sends the received password to the server 1 in response to the password prompt. When authentication based on the user ID and password is finished normally so that login is permitted, a telnet session between the mapper 5 and the server 1 is started, and simultaneously, a session between the client terminal 2 and the server 1 is also started. The connection managing section 81 of the mapper 5 sends to the web server 4 the result about permission or nonpermission of login and following data received from the server 1.

When the foregoing data is received, the request processing section 33 of the web server 4 sends those data to the client terminal 2 as a POST response. In this event, when login to the server 1 is permitted, the previously produced session ID is included in the sending contents. After the POST response, the HTTP session between the client terminal 2 and the web server 4 is finished. In this event, in the client terminal 2, the data from the server 1 that is sent as the POST response is added to the ring buffer 11 or 12, and the contents of the data are displayed in the display region 65 or 79. For example, in the display region 79 of the client terminal 2b, the contents of a portion above a broken line 80 are displayed. Further, when login to the server 1 is permitted, the session managing section 31 retains the previously produced session ID, the previously received user ID, password, host address, host port, mapper address and mapper port, a time stamp indicating a current time in milliseconds, a pointer to the ring buffer defined correspondingly to the session ID and its contents, a pointer to the foregoing socket indicating which of the connection managing sections 81 of the mapper 5 connection is made to, and the contents of the socket.

When there is no data transmission from the mapper 5 or the client terminal 2 over 10 minutes from a time instant indicated by the time stamp with respect to any of the session IDs, the session managing section 31 of the web server 4 forcibly terminates a corresponding telnet session with the server 1, deletes the session information such as the user ID corresponding to such a session ID, and releases the corresponding ring buffer 35.

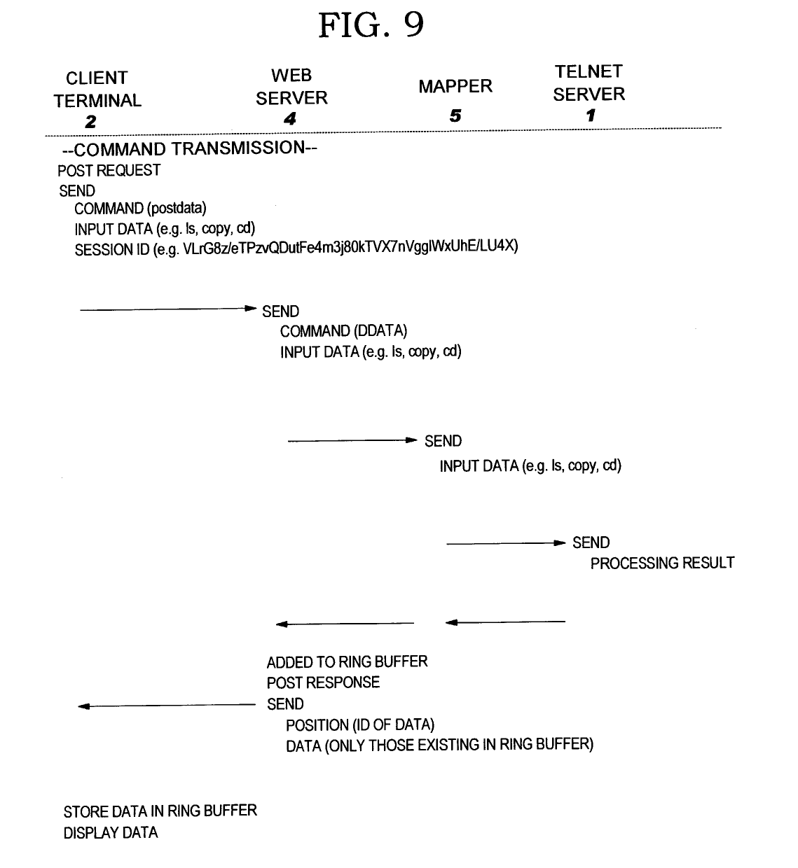

After the session between the client terminal 2 and the server 1 is established as described above, if a telnet command is inputted in the command input field 63 or 78 of the client terminal 2 and the send button 64 or 74 is depressed, the request sending/receiving section 45 of the client terminal 2 adds a command “postdata” and the session ID of the session to the inputted telnet command, and sends them to the web server 4 as a POST request via a new HTTP session, as shown in FIG. 9.

When the POST request is received, the request processing section 33 of the web server 4 adds a command “DDATA” to the telnet command in response to the command being “postdata”. The mapper connection managing section 32 sends the telnet command added with the command “DDATA” to the mapper 5 using a socket to the mapper 5 corresponding to the session ID. The connection managing sections 81 and 82 of the mapper 5 corresponding to the socket send the telnet command to the server 1 in the corresponding telnet session. When the telnet command is received, the server 1 executes processing according to the telnet command and sends a processing result to the mapper 5. When the processing result is received, the connection managing sections 81 and 82 of the mapper 5 send the received processing result to the web server 4.

When the processing result is received, the mapper connection managing section 32 of the web server 4 sends data about the received processing result to the ring buffer processing section 34. When the result data is received, the ring buffer processing section 34 adds the result data to the end of the ring buffer 35 corresponding to the session ID. Further, the request processing section 33 sends the data added to the ring buffer 35 and position data representing a position of the end of the added data in the ring buffer 35, to the client terminal 2 as a POST response. The request sending/receiving section 45 of the client terminal 2 receives the processing result sent from the web server 4, thereby to terminate the HTTP session. The synchronous processing section 47 adds the received processing result to the end of the ring buffer 11 or 12 and displays it in the display region 65 or 79. On the other hand, data about a processing result sent from the server 1 via the mapper 5 subsequent to sending of such a POST response is further added to the ring buffer 35, and the added data is sent to the client terminal 2 along with a processing result relative to the next telnet command, or in response to an update command “getdata” when such a command is sent from the client terminal 2 prior to that.

When the update button 66 or 75 in the client terminal 2 is depressed, the request sending/receiving section 45 of the client terminal 2 sends an update command “getdata” as a GET request along with the previously acquired session ID and position data, to the web server 4 as shown in FIG. 10. When the request processing section 33 of the web server 4 receives the session ID and the position data, the ring buffer processing section 34 reads out data in the ring buffer 35 subsequent to a read position represented by the position data as update data. The request processing section 33 sends the read update data along with a position of the end of the ring buffer 35 to the client terminal 2 as a GET response. When the request sending/receiving section 45 of the client terminal 2 receives the update data sent from the web server 4, the synchronous processing section 47 adds the update data to the ring buffer 11 or 12 and displays the update data in the display regions 65 or 79.

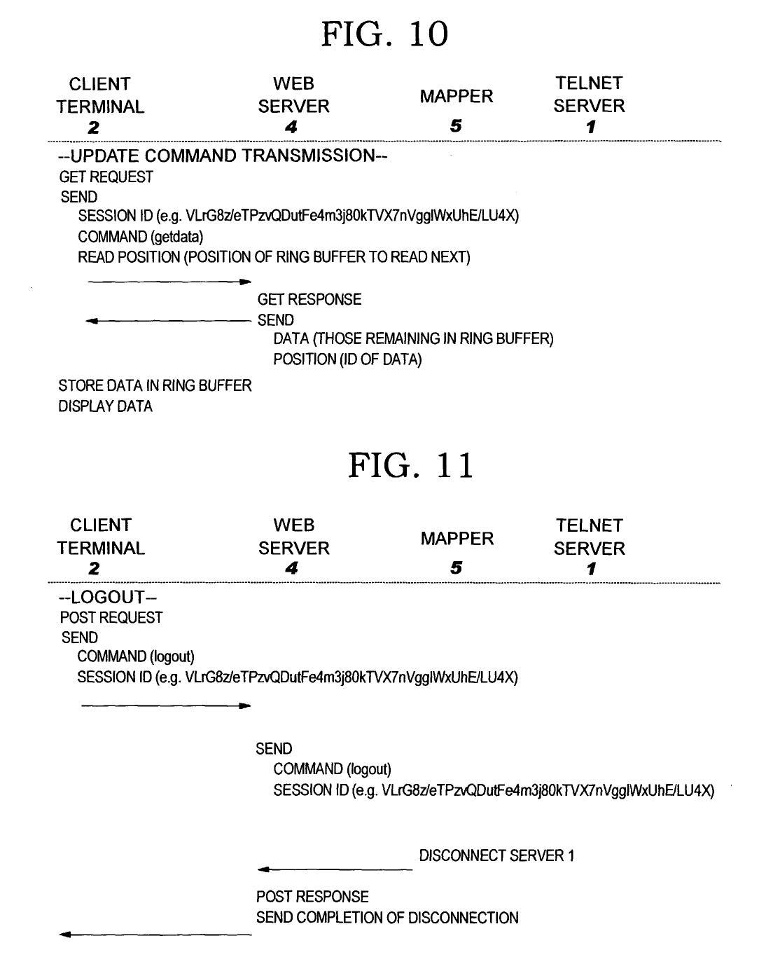

In the client terminal 2, when the end button 54 or 77 is depressed, the request sending/receiving section 45 sends a command “logout” commanding logout along with the session ID to the web server 4 as a POST request, as shown in FIG. 11. When the command “logout” is received, the request processing section 33 of the web server 4 sends a command “DLOGOUT” commanding logout along with the received session ID to the mapper 5.

When the data of the command “DLOGOUT” etc. is received, the connection managing section 81 of the mapper 5 sends the received data to the connection managing section 82. In response to the sending, the connection managing section 82 disconnects a telnet connection with the server 1 corresponding to the received session ID, thereby to terminate the telnet session. The connection managing section 82 notifies the connection managing section 81 of the termination of the telnet session, and the connection managing section 81 notifies the web server 4 of the termination of the telnet session.

When the notification of the termination of the telnet session is received, the mapper connection managing section 32 of the web server 4 intercepts connection to the mapper 5 with respect to the corresponding session ID. Further, the session managing section 31 deletes the session information 36 and the contents of the ring buffer 35 with respect to such a session ID. Further, the request processing section 33 sends a message of the completion of disconnection to the client terminal 2 as a POST response. Accordingly, the session between the client terminal 2 and the server 1 is finished.

The present invention is not limited to the foregoing preferred embodiment, but can be embodied with proper modifications. For example, in the foregoing preferred embodiment, explanation has been made of the case wherein telnet is used as the second protocol in the present invention, but another protocol such as FTP or Rlogin may be used instead of telnet.

Further, in the foregoing preferred embodiment, explanation has been made of the case wherein the client terminal 2 is connected to the server 1 via the Internet 8. However, the present invention is also applicable to the case wherein the client terminal 2 is connected to the server 1 via a network other than the Internet, such as another intranet 13 shown in FIG. 1.

Further, in the foregoing preferred embodiment, the web server 4 is connected to the server 1 via the mapper 5. However, unless the firewall 7 exists, the web server 4 may be directly connected to the server 1.

According to the foregoing preferred embodiment, a session between the client terminal 2 and the server 1 is established by relaying between an HTTP session with the client terminal 2 and a telnet session with the server 1. Thus, by disposing a firewall on the HTTP session, the virtual telnet session can be conducted between the client terminal 2 and the server 1, passing through the firewall. Further, in this event, the processing result from the server 1 is stored in the ring buffer 35 and transferred to the client terminal 2 in response to a request from the client terminal 2. Therefore, even such a processing result that is sent from the server 1 while the HTTP session is disconnected can also be sent to the client terminal 2 without failure. If the client terminal 2 is like the portable terminal 2a that is poor in hardware resource, the memory capacity may become insufficient when a large amount of the processing result is sent thereto at once. However, in the foregoing preferred embodiment, since the processing result is sent via the ring buffer 35 in response to an update request, such a failure can be avoided.

As described above, according to the present invention, first and second sessions are conducted between first and second information processing systems according to first and second protocols and, by relaying between a plurality of first sessions and one second session, a third session composed of those sessions is established, and processing result data sent from the second information processing system is sent to the first information processing system in response to a processing request from the first information processing system. Therefore, even if a firewall preventing the second session from passing therethrough exists on the first session, a session can be established between the first and second information processing systems. Further, since the processing result sent from the second information processing system to the first information processing system is stored in a buffer and transferred to the first information processing system from the buffer in response to an update request, even such a processing result that is sent while the first session is disconnected can also be received by the first information processing system without failure.

What is claimed is:

1. A session relay system that conducts a plurality of first sessions with a first information processing system according to a first protocol, and a second session with a second information processing system according to a second protocol, and relays between the plurality of first sessions and one said second session to establish a third session composed of those sessions, said session relay system comprising:
session managing means for producing ID information for identifying said third session that is established in response to a connection request from said first information processing system, and sending said ID information to said first information processing system having made said connection request; and
processing result transfer means for sending data of a processing result to said first information processing system, said data of the processing result sent from said second information processing system in response to a processing request sent from said first information processing system along with said ID information.

2. A session relay system according to claim 1, wherein said processing result transfer means comprises buffer means for storing the data of the processing result sent from said second information processing system in response to said processing request, in a buffer correspondingly to the ID information sent along with said processing request, and update means, responsive to an update request along with said ID information from said first information processing system, for sending data in the buffer corresponding to said ID information to said first information processing system, said data in the buffer not yet sent to said first information processing system.

3. A session relay system according to claim 2, wherein said connection request and said update request are made via the different first sessions.

4. A session relay system according to claim 2, wherein said buffer is a ring buffer provided per said ID information, and said buffer means adds said data of the processing result to the corresponding ring buffer, and sends said data of the processing result to said first information processing system along with position information relating to a position of the end of said added data in said ring buffer after the addition of said data, and further adds to said corresponding ring buffer in sequence data of the processing result that is sent subsequently to disconnection of said first session following the termination of the data sending to said first information processing system.

5. A session relay system according to claim 4, wherein, upon sending the data of the processing result in response to the update request accompanied by the ID information, said update means sends to said first information processing system data subsequent to said position, which is sent along with said update request, in said ring buffer corresponding to said ID information.

6. A session relay system according to claim 1, wherein said first information processing system exists outside a first firewall, said session relay system and said second information processing system exist inside said first firewall, and said first session can be conducted by passing through said first firewall.

7. A session relay system according to claim 6, wherein said session relay system comprises a third information processing system that conducts the first session with said first information processing system, and a fourth information processing system that conducts the second session with said second information processing system and is capable of communicating with said third information processing system according to a third protocol, and wherein communication between said third and fourth information processing systems according to said third protocol is conducted by passing through a second firewall, said third information processing system includes said session managing means, and said fourth information processing system establishes the second session with said second information processing system and relays between the communication according to said third protocol and the communication according to said second protocol.

8. A session relay system according to claim 1, wherein said first protocol is HTTP.

9. A session relay system according to claim 1, wherein said second protocol is telnet.

10. A client terminal comprising:
connection requesting means for receiving a connection request for connection to a predetermined server and sending said connection request to a predetermined session relay system via a session according to a predetermined protocol;
ID information receiving means for receiving ID information sent from said session relay system for identifying an upper session with said server, said upper session including said session and established in response to said connection request;
processing requesting means for receiving a processing request to said server and sending said processing request to said session relay system along with said ID information;
update requesting means for sending an update request to said session relay system along with said ID information, said update request requesting an update by data of a processing result sent from said server in response to said processing request and stored in said session relay system; and
display means for displaying data sent from said session relay system in response to said update request.

11. A session relay method that conducts first sessions with a first information processing system according to a first protocol, and a second session with a second information processing system according to a second protocol, and relays between the plurality of first sessions and one said second session to establish a third session composed of those sessions, said session relay method comprising:
a session managing step of producing ID information for identifying said third session that is established in response to a connection request from said first information processing system, and sending said ID information to said first information processing system having made said connection request; and
a processing result transfer step of sending data of a processing result to said first information processing system, said data of the processing result sent from said second information processing system in response to a processing request sent from said first information processing system along with said ID information.

12. A session relay method according to claim 11, wherein said processing result transfer step comprises a storing step of storing the data of the processing result sent from said second information processing system in response to said processing request, in a buffer correspondingly to the ID information sent along with said processing request, and an update step of, responsive to an update request along with said ID information from said first information processing system, sending data in the buffer corresponding to said ID information to said first information processing system, said data in the buffer not yet sent to said first information processing system.

13. A session relay method according to claim 12, wherein said connection request and said update request are made via the different first sessions.

14. A session relay method according to claim 12, wherein said buffer is a ring buffer provided per said ID information, and said storing step adds said data of the processing result to the corresponding ring buffer, and sends said data of the processing result to said first information processing system along with position information relating to a position of the end of said added data in said ring buffer after the addition of said data, and further adds to said corresponding ring buffer in sequence data of the processing result that is sent subsequently to disconnection of said first session following the termination of the data sending to said first information processing system.

15. A session relay method according to claim 14, wherein, upon sending the data of the processing result in response to the update request accompanied by the ID information, said update step sends to said first information processing system data subsequent to said position, which is sent along with said update request, in said ring buffer corresponding to said ID information.

16. A session relay method according to claim 11, wherein said first information processing system exists outside a first firewall, said session relay system and said second information processing system exist inside said first firewall, and said first session can be conducted by passing through said first firewall.

17. A session relay method according to claim 16, wherein the first session with said first information processing system is conducted by a third information processing system, and the second session with said second information processing system is conducted by a fourth information processing system capable of communicating with said third information processing system according to a third protocol, and wherein communication between said third and fourth information processing systems according to said third protocol is conducted by passing through a second firewall, said third information processing system performs said session managing step, and said fourth information processing system establishes the second session with said second information processing system and relays between the communication according to said third protocol and the communication according to said second protocol.

18. A session relay method according to claim 11, wherein said first protocol is HTTP.

19. A session relay method according to claim 11, wherein said second protocol is telnet.

20. A remote access method comprising:
a connection requesting step of receiving a connection request for connection to a server inside a firewall and sending said connection request to a session relay system inside said firewall via one session according to a protocol that can pass through said firewall;
an ID information receiving step of receiving ID information sent from said session relay system for identifying an upper session with said server, said upper session including said one session and established in response to said connection request;
a processing requesting step of receiving a processing request to said server and sending said processing request to said session relay system along with said ID information;
an update requesting step of sending an update request to said session relay system along with said ID information via a session, other than said one session, according to said protocol and included in said upper session, said update request requesting an update by data of a processing result sent from said server in response to said processing request and stored in said session relay system; and
a display step of displaying data sent from said session relay system in response to said update request.

21. A remote access method according to claim 20, further comprising a step of storing a position of the end of a ring buffer of said session relay system sent from said session relay system along with the data of the processing result, wherein, upon sending said update request, said update requesting step sends the stored newest position simultaneously.

22. A remote access method according to claim 20, wherein said protocol is HTTP.

23. Computer readable program code comprising:
connection requesting means for receiving a connection request for connection to a predetermined server and sending said connection request to a predetermined session relay system via a session according to a predetermined protocol;
ID information receiving means for receiving ID information sent from said session relay system for identifying an upper session with said server, said upper session including said session and established in response to said connection request;
processing requesting means for receiving a processing request to said server and sending said processing request to said session relay system along with said ID information;
update requesting means for sending an update request to said session relay system along with said ID information, said update request requesting an update by data of a processing result sent from said server in response to said processing request and stored in said session relay system; and
display means for displaying data sent from said session relay system in response to said update request.

24. Computer readable program code for implementing a session relay method that conducts first sessions with a first information processing system according to a first protocol, and a second session with a second information processing system according to a second protocol, and relays between the plurality of first sessions and one said second session to establish a third session composed of those sessions, said session relay method comprising:
a session managing step of producing ID information for identifying said third session that is established in response to a connection request from said first information processing system, and sending said ID information to said first information processing system having made said connection request; and
a processing result transfer step of sending data of a processing result to said first information processing system, said data of the processing result sent from said second information processing system in response to a processing request sent from said first information processing system along with said ID information.
